(19) United States
(12) Patent Application Publication
(10) Pub. No.: US 2004/0246089 A1
(43) Pub. Date: Dec. 9, 2004

(54) Dc to dc converters

(76) Inventor: John Stephens, Hents (GB)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/485,890

(22) PCT Filed: Aug. 2, 2002
(86) PCT No.: PCT/GB02/03568

(30) Foreign Application Priority Data
Aug. 3, 2001 (GB) 01189794
Sep. 24, 2001 (GB) 01229319

(51) Int. Cl. H01F 27/24

(52) U.S. Cl. 336/212

(57) ABSTRACT

The transformer of a DC to DC converter is constructed as a pair of E-shaped core elements (10, 20) forming a transformer with two outer legs (13, 14) and an inner leg (12) which has approximately half the cross-section of the outer legs. The windings are formed on a support structure with two wire (32, 33) side by side on each outer leg, and two strip windings (see 16, 40) one over the other on the centre leg.

The present invention relates to DC to DC converters, typically for a power supply for supplying a continuous output current from a continuous input current, for use for example as power supplies in automotive, computing, or telecoms applications or the like.

One aspect of the present invention relates particularly to the physical arrangement of transformer and inductor windings in a DC to DC converter.

A known DC to DC converter is described in U.S. Pat. No. 5,886,882 (Rodolpho), which features primary and secondary transformer windings, together with two pairs of primary and secondary choke windings, wound upon a three limbed core. A switching circuit is coupled between the first primary choke and the primary transformer winding, and a similar switching circuit is coupled between the first secondary choke and the primary transformer winding. The switching circuits are switched on and off in a cyclic manner to provide a continuous output current from a continuous input current in a push-pull manner.

The core is made up of two E-shaped halves, one carrying the primary windings, and the other carrying the secondary windings. In each half ,the outer two limbs are slightly shorter than the centre limb. The metal wire or strip is wound around the appropriate limb, and the two core halves are brought together so that the centre limbs touch and the two pairs of outer limbs are spaced slightly from one another. Spacing elements may be included between each outer limb pair.

Applying the metal wires or strips around the limbs of the cores is awkward due the shape of the cores, since the winding process is impeded by the limbs neighbouring that which is being wound. It is difficult to apply more than one winding at a time, so the process is also time-consuming.

It is an object of the present invention to provide a winding arrangement that is convenient to manufacture.

According to one aspect of the present invention there is provided a transformer element for transforming a voltage from a primary circuit to a secondary circuit, the transformer element including (a) part of the primary circuit including a first induction winding, a transformer winding, a second inductor winding, (b) part of the secondary circuit including a first induction winding, a transformer winding, a second inductor winding, and (c) a core means that extends through one or more of the windings, characterised in that one or more of the windings through which the core means extend is disposed upon a forming element discrete from the core means and through which the core means extends.

Preferably the first primary inductor winding and the first secondary inductor winding are disposed on a first forming element, the primary transforming winding and secondary transformer winding are disposed on a second forming element, and the second primary inductor winding and second secondary inductor winding are disposed on a third forming element.

Preferably the second forming element is secured directly to the first and third forming elements. The first and third forming elements preferably each includes an integral spacing portion which constrains the respective primary inductor winding and the secondary inductor winding in a spaced relationship. Preferably the primary transforming winding and secondary transformer winding are arranged in an overlapping configuration.

Preferably the winding comprises an elongate conducting element, this conducting element comprising a turn portion which is wound into a number of turns around the circumference of the forming element, and connecting portions, which connect the turn portion to the primary or secondary circuit, and that the forming element includes channels or protuberances to guide and/or secure the connecting portions.

Preferably the winding comprises an elongate conducting element, this conducting element comprising a turn portion which is wound into a number of turns around the circumference of the forming element, and connecting portions, which connect the turn portion to the primary or secondary circuit, and that the forming element includes a groove to accept part of the connecting portion, the turn portion being formed above this groove.

According to another aspect of the present invention, there is provided a method of manufacturing a transformer element for transforming a voltage from a primary circuit to a secondary circuit, comprising the steps of winding an primary elongate conductor to a forming means, winding a secondary conductor to a forming means, connecting the primary elongate conductor to the primary circuit and the secondary elongate conductor to the second circuit, and introducing a core means to the forming means subsequent to the conducting means having been wound upon the forming means.

Preferably the method is further characterised by:

winding a first primary inductor winding and a first secondary inductor winding onto a first forming element, winding a primary transforming winding and a secondary transformer winding onto a second forming element, and winding a second primary inductor winding and a second secondary inductor winding onto a third forming element; and

inserting a first core element having three limbs into the first second and third forming elements, and inserting a second core element having three limbs into the first second and third forming elements, from the opposite side to the first core element, the insertion of the core elements into the forming elements being carried out subsequently to winding the inductor windings and transformed windings onto the forming elements.

A further aspect of the present invention relates to the cores of DC to DC converters.

Transformers used in electrical and electronic applications for “transforming” an input voltage to a higher or lower voltage (and often referred to as “Buck” and “Boost” converters respectively) are well known to persons skilled in the art. A problem with known transformers is to provide efficient assemblies which operate with both continuous input and output currents. It is also desirable to minimise the total size and weight of the transformer.

Known DC to DC converters, for example a uk converter (shown in U.S. Pat. No. 4,184,197), feature primary and secondary transformer windings, together with a primary and secondary choke winding, wound upon a three limbed core. A switching circuit is coupled between the first primary choke and the primary transformer winding. The switching circuit may comprise a capacitor and a MOSFET. The switching circuit is switched on and off in a cyclic manner to provide a continuous output current from a continuous input current.

A further continuous DC-to-DC converter has been described in EP 0 759 654 A1. That system has two matching converter units, each of which has a primary section unit and a secondary section unit coupled together via a transformer. The primary section of each unit comprises an inductor coupled to the primary section of the transformer via a capacitor and switching means connected across the capacitor and primary winding means of the transformer. The secondary section of each unit comprises a diode rectifier connected to secondary winding means of the transformer.

The switching means is operated in two alternating phases. One phase is an inductor charging phase in which the input current path flows just through the inductor and the current in the inductor increases (“charging” the inductor); the other phase is a capacitor charging phase in which the current through the inductor is directed into the capacitor to charge the capacitor. The capacitor discharges during the inductor charging phase, and the inductor “discharges” during the capacitor charging phase (ie the current in the inductor decreases).

The two converter units are connected in parallel. Each switching means is a change-over switch connected to both sides of the respective capacitor. The secondary side of the system comprises a bridge circuit with two adjacent arms comprising secondary windings coupled to the respective primary side inductors; the remaining two arms comprising rectifying diodes poled such that the capacitor charge phase of each unit contributes to the output, through the coupling between the inductor and the secondary winding of that unit. During each inductor charging phase of each unit, the secondary winding for that unit has a reverse voltage induced in it which is blocked by the associated diode. Each unit thus contributes to the output during its capacitor charging phases, with “gaps” during its inductor charging phases.

The two units are operated in an interleaved manner with the inductor charge phase of each occurring within the capacitor charge phase of the other. The capacitors of the two units are connected to opposite ends of a common primary winding coupled to a secondary winding forming the cross arm of the bridge circuit. During each inductor charge phase, this common primary winding is short-circuited, and the current in it induces a voltage in the secondary winding of the cross arm of the output bridge circuit. This voltage acts to oppose and indeed overcome the reverse voltage in the secondary bridge mentioned above. Thus for each unit, the gaps in the output between successive capacitor charging phases are filled by the signals from the cross arm secondary winding.

The result is a converter in which the input and output DC currents are both substantially continuous.

The general object of the present invention is to provide a DC to DC converter and method of driving it more efficiently produce a continuous output current for a continuous input current.

According to this aspect of the invention there is provided a continuous DC-to-DC converter comprising:

a transformer having two outer legs and a middle leg,

a primary side comprising

a first primary inductor wound on one outer transformer leg and connected between one side of the DC input and a first capacitor,

a second primary inductor wound on the other outer transformer leg and connected between one side of the DC input and a second capacitor,

first switching means comprising a change-over switch connecting the other side of the DC input to the two sides of the first capacitor,

second switching means comprising a change-over switch connecting the other side of the DC input to the two sides of the second capacitor, and

a common inductor wound on the middle transfonner leg and connected to the first and second capacitors on the sides opposite the first and second inductors respectively, and

a secondary side comprising a bridge circuit having two adjacent legs forming secondary inductors wound on the respective outer transformer legs, two adjacent legs including respective rectifying means, and a cross path forming a common secondary winding on the middle transformer leg, the first and second primary inductors being wound on the respective legs of the transformer in opposite senses, such that corresponding currents through them induce magnetic fluxes in opposite directions through the middle transformer leg,

characterized in that

the cross-sectional area of the middle leg is less than that of each of the two outer legs.

By arranging the windings and utilising the upper and lower legs in this way, the peak magnetic flux in the central leg is considerably reduced, reducing the core losses, and it has further been realised that the cross sectional area of the central leg can therefore be reduced to any value dependent on the summation of the magnetic flux from the other windings and acceptable core losses.

According to another aspect of the invention, there is provided a DC-DC transformer including primary and secondary transformer windings, a first primary and secondary choke winding, and a second primary and secondary choke winding, and a control means that switches current to flow through the first primary choke winding and the primary transformer winding, and/or through the second primary choke winding and the primary transformer winding so as to induce a current in the secondary transformer winding, the first primary and secondary choke windings being magnetically associated with a first core member, the primary and secondary transformer windings being magnetically associated with a second core member, and a second primary and secondary choke winding being magnetically associated with a third core member, characterized in that the second core member has a cross sectional area equal or less than approximately half the cross sectional area of either the first core member or the third core member.

A DC to DC converter embodying the invention will now be described, by way of example, with reference to the accompanying drawings, in which:

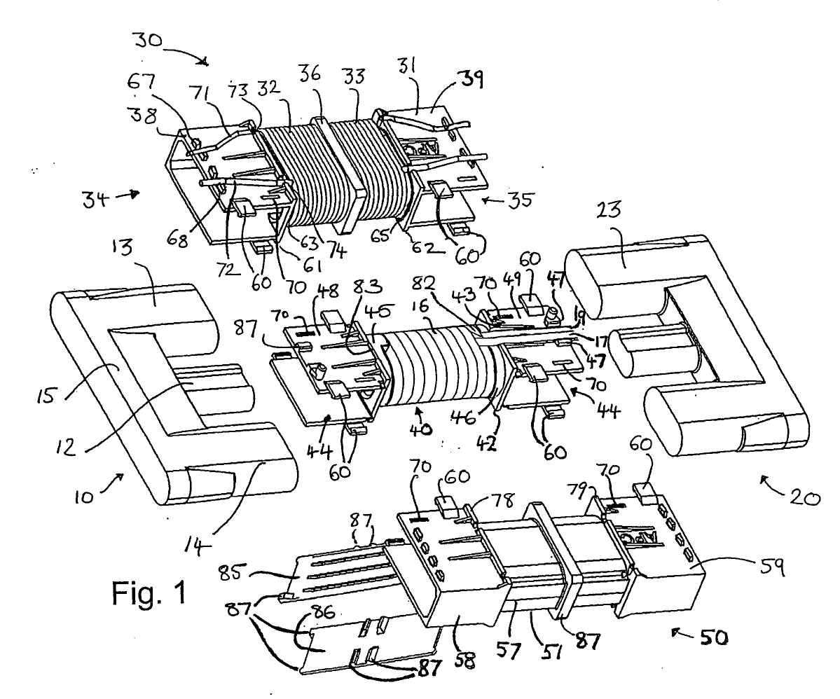

FIG. 1 is an exploded perspective view of the front of the winding arrangement;

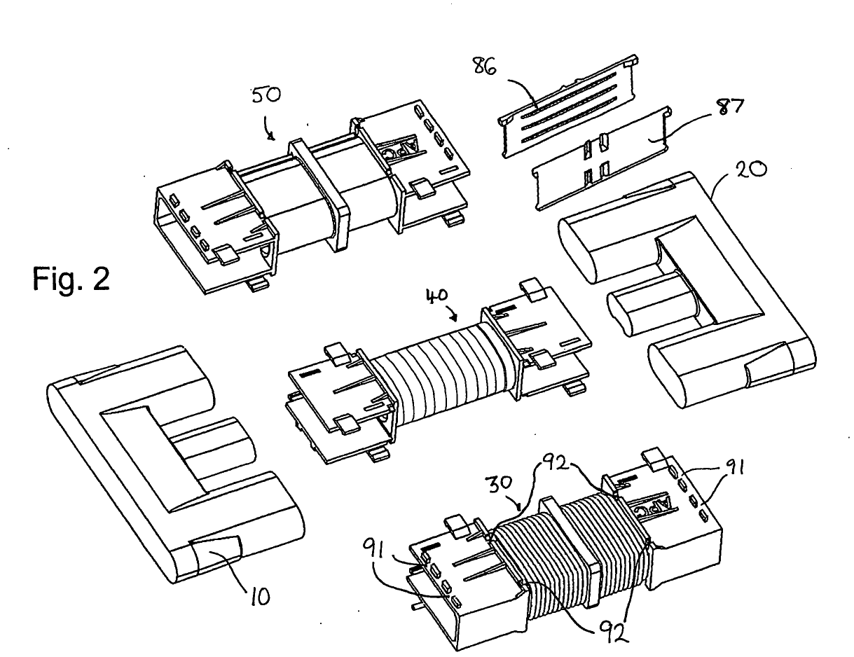

FIG. 2 is an exploded perspective view of the rear of the winding arrangement;

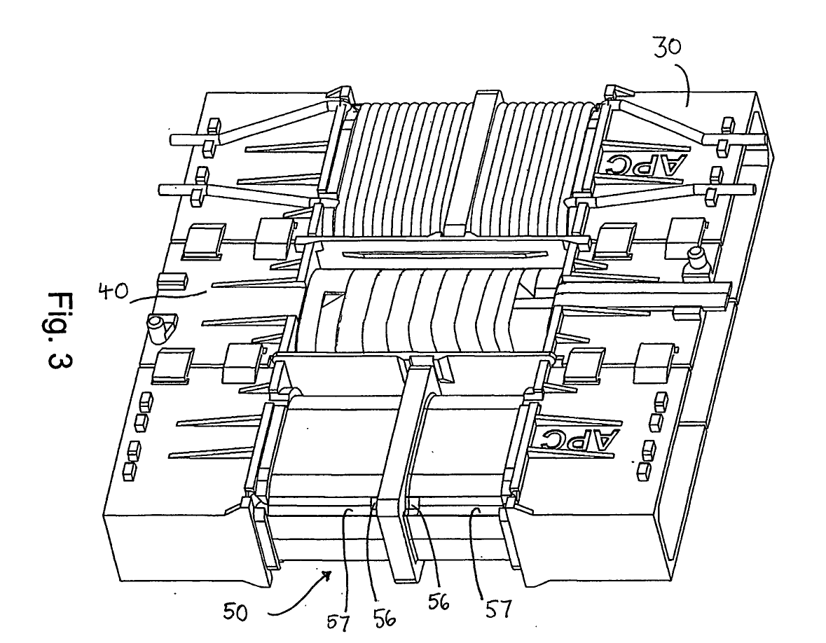

FIG. 3 is a perspective view of the front of the assembled winding arrangement;

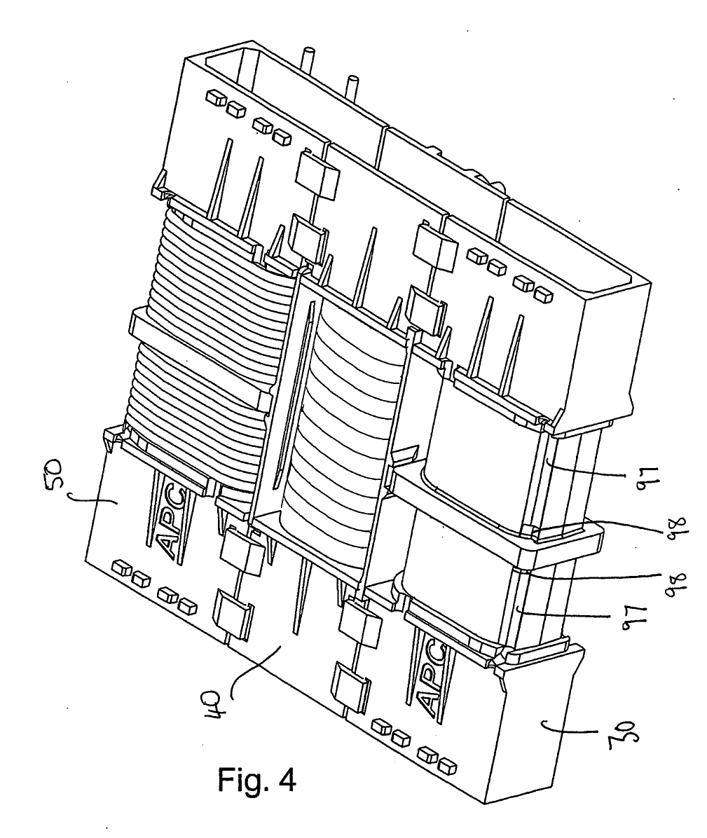

FIG. 4 is a perspective view of the rear of the assembled winding arrangement;

FIG. 5 is a cross sectional view of the winding arrangement;

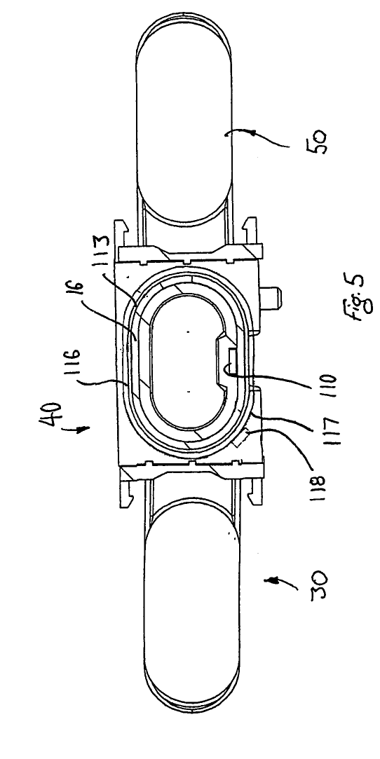

FIG. 6 shows the basic switching phases of the circuit;

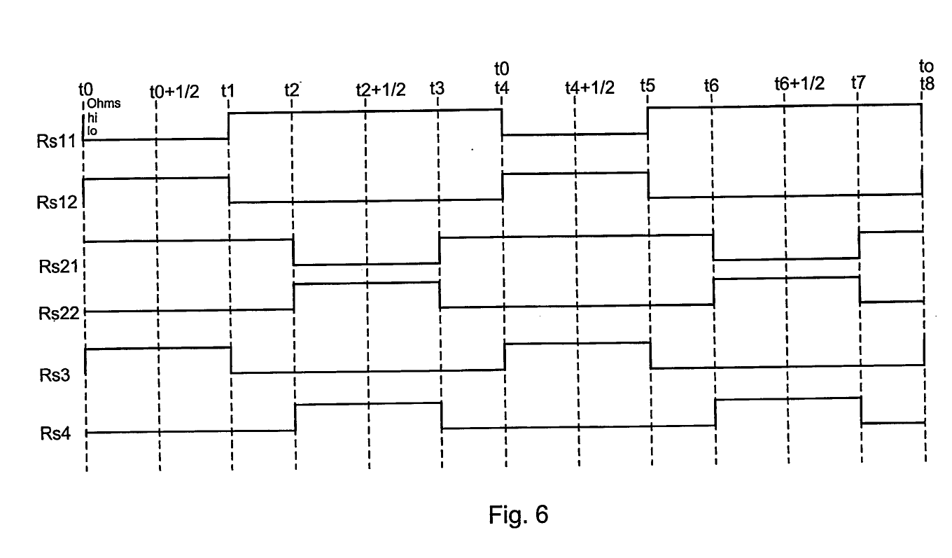

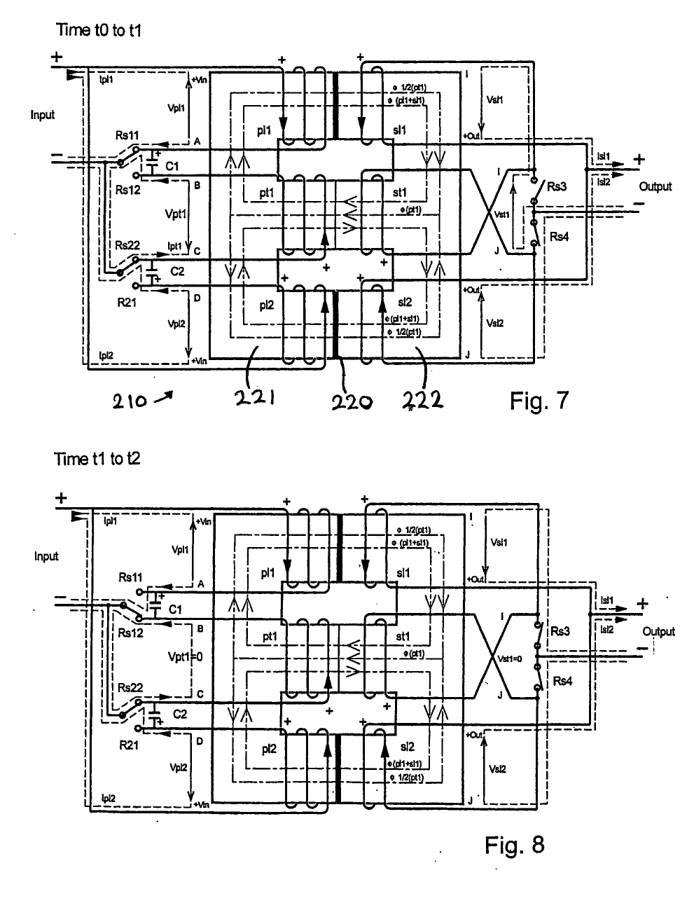

FIGS. 7-10 shows the converter circuit and its states during the various phases;

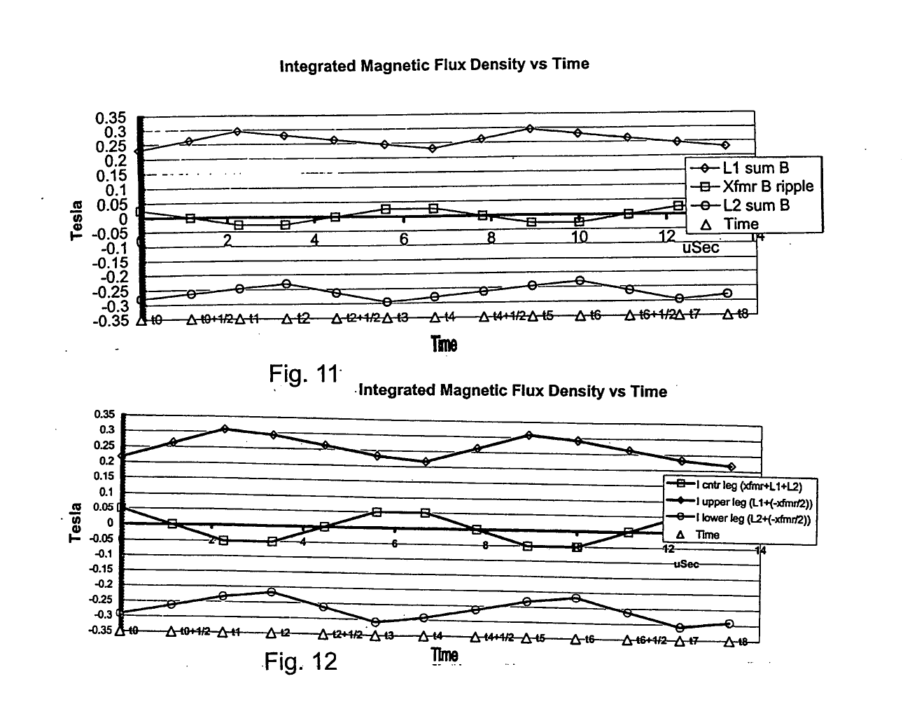

FIG. 11 shows the magnetic flux density generated by the windings;

FIG. 12 shows the magnetic flux density in the core members; and

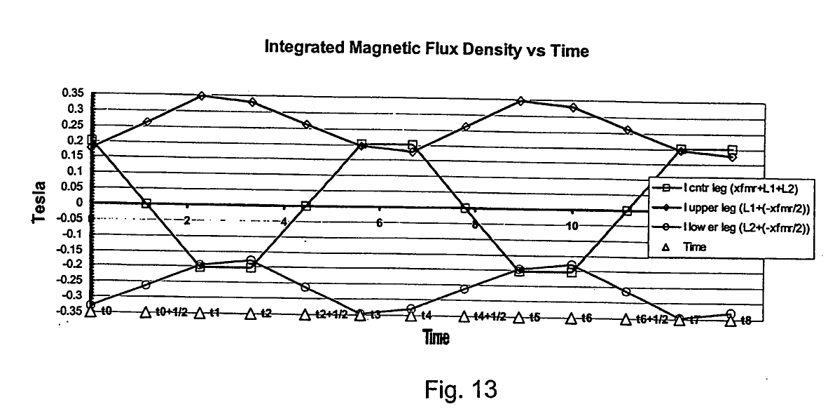

FIG. 13 shows the magnetic flux density in another embodiment of the core members.

In the following text the winding unit 30 appearing uppermost in FIG. 1 will be referred to as the ‘upper’ winding unit and the side of the winding arrangement in which the sides of the three winding units 30, 40, 50 all face upwards in FIG. 1 will be referred to as the ‘front’ of the arrangement, and ‘lower’, ‘rear’ and cognate terms should be interpreted accordingly, though of course the orientation of the transformer is arbitrary.

Referring to FIG. 1, the winding arrangement comprises primary and secondary core halves 10, 20, upper and lower inductor winding units 30, 50, and a transformer winding unit 40. The primary core half 10 is approximately ‘E’ shaped, the centre limb 12 being somewhat longer than the upper or lower limbs 13, 14. The backbone 15 joining and running perpendicular to the three limbs is slightly thicker than the limbs. The central limb 12 has a smaller cross section than the upper or lower limbs 13, 14, and the backbone 15 is slightly tapered to allow the core half to be cleanly removed from its mould or press during manufacture. The secondary core half 20 is similar to the primary core half.

The upper inductor winding unit 30 comprises an upper former 31 and a primary and secondary inductor coils 32, 33. The upper former includes a cavity 34 extending through the length of the upper former 31, the cavity accommodating the upper limbs 13, 23 of the primary and secondary core halves 10, 20. When the core halves are placed together, the ends of the upper limbs are separated by an air gap. The outer surface of the upper former has two winding regions (not here visible), separated by a divider 36. This divider substantially corresponds to the air gap formed in the internal cavity between the air gap. At each end of the former is a shoulder portion 38, 39, which is approximately cuboid form, and has a larger thickness and width than the winding regions. The shoulder portions 38, 39 include flanges 61,62 where they meet the winding regions. Each winding region includes a spacer portion 63,65 which lies against the shoulder portions' flanges. The cavity 34 is also larger at the shoulder portions, their thickness and width corresponding to the shape of the backbone of the core halves 10, 20.

The shoulder 38 includes guideways 67, 68 which constrain the two wires 71, 72 that connect the primary inductor coil 32 to the primary circuit. The flange 61 also includes two channels 73, 74 for the wires' paths. To apply the wire to make up the primary inductor coil 32, a length is applied to lie in the distal guideway 67 and the distal lip channel 73, and the wire is then placed along an axial groove in the winding surface (the axial groove of the primary inductor winding unit is not here visible, but corresponds to the axial groove 57 of the lower former 50). A winding channel in the winding surface runs along the divider 36 (again not here visible, but corresponding to the winding channel 98 of the lower former 50 visible in FIG. 4). When wire reaches the divider 36, the wire is bent perpendicularly and disposed along the winding channel. At the end of the winding channel, the wire is wrapped around the former 31 in a complete turn, abutting the divider 36. This turn of the wire thus covers the portion of the wire lying in the upper channel. The wire is then coiled around the former 31, each new turn lying next to the previous turn. The last turn applied lies against the flange 61, and where the last turn is completed, the flange includes a proximal channel 74, and the wire is laid through this channel and then through the proximal guideway 68. The upper primary inductor coil has now been applied.

The upper secondary inductor coil 33 is applied in a corresponding manner. The lower inductor coils are formed on a lower former 51 which is similar in form to the upper former, and the lower primary and secondary inductor coils (not here shown) are applied in a similar way.

The centre former 40 includes a single winding surface, whose axial length is approximately equal to that of the two winding surfaces and divider 36 of the upper former combined. The centre former also includes a single open-ended cavity 44, this cavity extending the entire length of the centre former. In a similar manner to the upper and lower formers, the centre former includes shoulder portions 48, 49 at each end of the centre former, these shoulder portions being having a greater height and width than the winding surface. Again in a similar manner to the upper former, the shoulder portions 48, 49 include flanges 41, 42.

The shoulder of the centre former includes guideways 47, and the flange 42 includes a channel 43 for the passage of the metal strip 16 (only one transformer coil is here shown) to connect the winding to the primary and secondary circuits. To apply the strips to the centre former, a first end 17 of the strip 16 is laid through a guideway 47 and the flange channel 43. The strip 16 then runs axially along the upper surface of the winding surface in an axial channel 110 (visible in FIG. 5), until the strip reaches the end of the winding surface. The strip is then folded so that its direction turns perpendicularly (this fold 81 is visible in FIG. 3). The strip is then wound around the winding region of the former. The flange includes a stepped spacer portion 45, which at its widest is the width of the strip, the width of this step then gradually and constantly reducing around the circumference of the former. The strip 16 is wound around the forming surface, the first turn abutting the stepped spacer portion 45, and subsequent turns abutting the previous turns. The last turn of the strip abuts a stepped spacer portion 46 at the opposite end of the winding region, which is stepped in a similar but opposite manner to the stepped spacer portion 45 first end of the winding surface. The strip 16 is then folded at 82 so that its direction is turned perpendicularly, and is led out of the flange channel 43 and through the guideway 47, this last portion of strip 19 lying next to the portion of strip 17 that was first installed in the guideway and channel.

A second metallic strip 116 (not visible in this figure) is placed through the guideway 87 and flange channel 83 on the opposite side of the former 40. It is then laid axially along the forming surface and wound around the forming surface in the same manner as the first strip (although it will start from the opposite end), and on top of the first strip 16, until second strip has been wound the length of the forming surface, whereupon it is folded to turn through 90°, and led through the flange channel 83 and guideway 87. Referring to FIG. 5, the first metallic strip 16 is covered by two layers of polyester tape 113. The second metallic strip 116 is then wound around the first metallic strip 16 and the polyester tape 113, so that the two layers are electrically insulated. A further two layers of polyester tape 117 are then wound around the second metallic strip 116, and the final portion of strip 118 then runs back along the winding to rejoin the secondary circuit.

The shoulders portions 38, 39, of the upper formers 30 comprise a three-sided generally cuboid box with the inner surface of each shoulder portion being profiled to snugly accept the backbone portion of a core half (as previously mentioned). The end side of this box is open, to accept the upper limb 13 of the core half into the cavity. The proximal side of the box is also open. The lower former is similarly configured, though the open proximal and closed distal sides of the shoulder's box will be opposite to the upper formers.

The shoulder region 48 of the centre former is formed from two planar portions, spaced in a parallel arrangement and forming the front and rear surface of a box which is open on both sides and of course at the end to allow the centre limb 12 of the core half to be introduced.

The front and rear sides of the shoulder regions 38, 39, 48, 49, 58, 59 include tabs 60 and grooves 70, such that the tab on one former interlocks with a corresponding groove on another former in a snap fit manner. Thus, after the metal wire and strip has been applied to the formers, the upper and lower formers 30, 50 are clipped to the centre former 40. Partition wall 85 is placed between the upper former 30 and the centre former 40 as they are clipped together, and similarly partition wall 86 is placed between the lower former 50 and the centre former 40. These partition walls 85, 86 include locating lugs 87 which engage with the flanges 61, 62, 78, 79 and the dividers 36,87 of the upper and lower formers 30, 50.

Referring to FIG. 2, it will be seen that the underside of the upper former 30 also features guideways 91 and flange channels 92. In this way, the same component may be used for both the upper former 30 and the lower former 50. The central former could also be equipped with guideways and flange channels on both its obverse and reverse sides so that it may be used in either orientation.

The axial grooves 57 of the lower former 50 and axial grooves 97 of the upper former 30 are best shown in FIGS. 3 and 4 respectively. These figures show the formers fully assembled (though without the lower inductor coils or the secondary transformer coil, or the core halves). Also visible are the winding channels 56 and 98 of the upper and lower formers respectively.

A typical size for the unit would be approximately 52 mm square, and have a thickness of approximately 10 mm, though the particular dimensions will depend upon the apparatus the transformer is to be installed in and the power conversion specification.

Each former may be conveniently made as an integral injection moulded plastic component.

It will been seen that the metal wires and strips may be applied to and wound around the formers in a straight-forward manner, since each former is separate from the other formers during the application of the metal wires and strips. Also, the upper inductor coils, transformer coils and lower inductor coils may be configured more closely together, since the winding means does not have to directly negotiate the separation of the limbs of the core halves. Further, it is now straightforward to lay the primary and secondary transformer coils one on top of the other, and so achieve a high coupling.

Turning now to the operation of the converter and in particular to its magnetic core, the converter (FIG. 7)comprises an input, an output, and a transformer assembly 210 having a ferrite core 220. The core is formed from two E-shaped core pieces 221, 222, each core piece having three legs. (Equally, an E-shaped core piece and an I-shaped core pieces could be used.) The core pieces are placed together so that each core piece's legs are adjacent to and aligned with the corresponding legs of the other core piece, so that the core now formed also has three legs. Primary and secondary transformer windings pt₁ and st1 are provided on the centre leg of the ferrite core. Windings pl₁ and sl₁ are provided on one outer leg to form a first pair of primary and secondary chokes, and windings pl₂ and sl₂ on the other outer leg form a second pair of primary and secondary chokes.

A capacitor C, is connected between the primary transformer winding pt₁ and the first primary choke winding pl₁. Similarly, a capacitor C₂ is connected between the primary transformer winding pt₁. and the second primary choke winding pl₂. Two switches RS₁₁ and RS₂₁ are coupled between the capacitor C₁ and the first primary choke winding pl₂ and between capacitor C₂ and the second primary choke winding pl₂ respectively. Similarly, two switches RS₁₂ and RS₂₂ are coupled between the capacitor C₁and the primary transformer winding pt₁, and capacitor C₂ and the primary transformer winding pt₁. The switches RS₁₁ and RS₁₂ and the capacitor C1 form a first switching circuit for the first primary choke winding pl₁and the switches RS₂₁ and RS₂₂ and the capacitor C₂ form a second switching circuit for the second primary choke winding Pl₂. For simplicity, the switch pair RS₁₁ and RS₁₂ and the switch pair RS₂₂ and RS₂₁ have both been shown as single switches having two contacts, since during operation, when one switch of the switch pair is opened, the other is substantially simultaneously closed, and vice versa, so it will be seen that a single switch having two contacts is an equivalent arrangement. The switches will typically be provided by some form of transistor, such as MOSFET devices.

An input voltage is applied to the first primary choke winding pl₁ and the first switching circuit, and to the second primary choke winding pl₂ and the second switching circuit.

In the secondary circuit, the secondary transformer winding st₁ is connected between the first secondary choke winding sll and the second secondary choke winding sl₂. Two switches RS₃ and RS₄ are coupled to points between the secondary transformer winding st₁ and the first secondary choke winding sl₁ and between the secondary transformer winding st₁ and the second secondary choke winding Sl₂. The secondary circuit effectively forms a bridge circuit; there are two paths (sl₁-RS₃ and Sl₂-RS₄) connected in parallel, with the secondary transformer winding st₁ forming a bridge path between them.

Each winding, when considered looking from the primary circuit to the secondary circuit, is wound around the relevant leg of the core by in a left handed sense (i.e. considered moving from the primary to the secondary circuit the wire making the coil is wound anticlockwise around the leg).

Referring to FIG. 7, the circuit operates in a cycle of four separate phases. In an initial state (say before t₀), switches RS₁₂ and RS₂₂ are closed in the primary circuit, while RS₁₁ and RS₂₁ are open. Switches RS₃ and RS₄ are both closed. Referring to FIGS. 7 to 10, capacitor C₁ is charged through the first primary choke winding pl₁ and similarly capacitor C₂ is charged through the second primary choke winding pl₂ at the input voltage. Capacitors C₁ and C₂ are sufficiently large to smooth the ripple voltage caused by switching, and the choke windings pl₁ and pl₂ are sufficiently large to smooth the ripple current.

Referring back to FIG. 7, at time to, switch RS₁₁ is closed and RS₁₂ and RS₃ are opened. The voltage across C₁ is applied (Vpt₁) to the primary transformer winding pt₁ inducing a secondary voltage at st₁. The current caused to increase through st₁ flows through RS₄ to contribute to the output, the total current through the output increasing to the sum of the currents flowing in sl₁ stl, and SL₂ The output voltage is dependent upon the turns ratio of the primary and secondary transformer windings pt₁ and st₁, the secondary choke arrangement halving the output voltage, with half the current flowing through each choke.

Referring to FIG. 8, at a time t₁, switch RS₁₁ is opened and RS₁₂ and RS₃ are closed. The primary transformer winding pt₁ is clamped by RS₂₂ and RS₁₂ to 0 volts, the stored energy in the primary transformer winding pt₁ circulating as current. The secondary transformer winding st₁ is clamped by the primary transformer winding. Energy stored in the first secondary choke winding sl₁ circulates as current through RS₃. Current through the first primary choke pl, decreases and capacitor C₁ recharges. Energy stored in the second choke circulates as current through the secondary winding Sl₂ and RS₄. Current through the second primary choke pl₂ decreases and capacitor C₂ recharges. The secondary transformer winding st₁ is clamped by the primary transformer winding pt₁ and the current through st₁ decreases to zero.

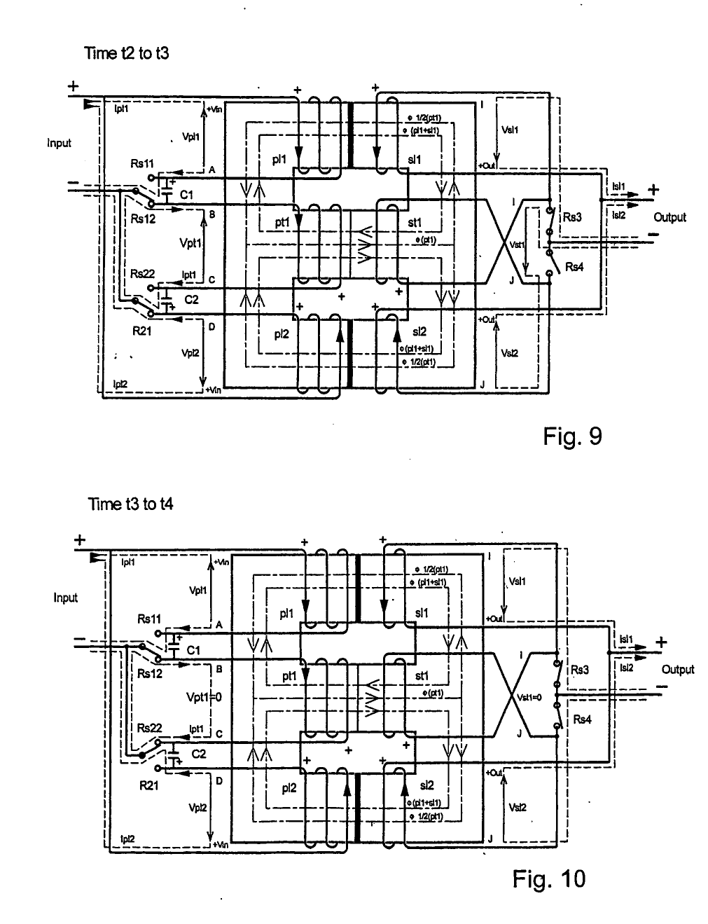

Referring to FIG. 9, at a time t₂, switches RS₂₂ and RS₄ are opened and RS₂₁ is closed. The charge on capacitor C₂ discharges through the primary transformer winding pt₁, taking the lower connection negative and causing a current to flow through RS₃ and st₁. As previously, the output voltage is dependent upon the turn ratio of the transformer windings.

Referring to FIG. 10, at a time t₃, switch RS₂₁ is opened and RS₂₂ and RS₄ are closed. The primary transformer winding ptl is clamped by RS₁₁ and RS₁₂ to 0 volts, the stored energy in the primary transformer winding pt₁ circulating as current. The secondary transformer winding st₁ is clamped by the primary transformer winding pt₁. Energy stored in the second secondary choke winding sl₂ circulates as current through RS₄.

At t₄, the circuit is switched as described from t₀, and the cycle is repeated indefinitely (a second cycle, from t₄ to t₈ is also shown here).

Looking at the operation from a slightly different point of view, from time t₀ to t₁, the primary choke winding pl₁ is charging; from time t₁ to t₄, this winding is discharging. During this discharge period, a current is induced in the secondary choke winding sl₁. During the charge period t₀ to t₁, an output current in the secondary side is induced by capacitor C₁ discharging through winding pt₁; this induces a secondary current in winding st, which overcomes the reverse voltage in winding sl₁ at this time and maintains the net output current. Similarly, the primary choke winding pl₂ provides output current via winding sl₂ during the period t₂ to t₅, and capacitor C₂ provides output current (overcoming the reverse voltage in winding sl₂) during the periods t₁ to t₂ and t₅ to t₆.

It can be shown that the output voltage, Vₒ, is given by

Vₒ=Nₛ/Nₚ·Vᵢ·D/(1−D)

where Vᵢ is the input voltage, NₛNₚ is the transformer turn ratio, and D is the duty cycle of the switching circuits given by D=tₒₙ/(2*T) where tₒₙ is the on-time of the switches Rs₁₁ and Rs₂₁ and T is the reciprocal of the clock frequency of the control circuit.

The switches are operated by a control circuit (not here shown). A typical switching cycle would be over a period of approximately 6.6 μs, with the time intervals between the subsequent times t₀, t₀+½, t₁, t₂, t₂+½, t₃ and t4 being approximately 1.1 μs, though of course other switching regimes may be used.

Looking again at FIGS. 7 to 10, in the time period t₀ to t₁, the dotted lines with arrows show the flux generated by the windings, and the direction that the flux flows in. The net flux through a core leg may be calculated simply by superimposing the fluxes generated by each set of windings, i.e. assigning to the magnitude of the flux a sign based on its direction around the magnetic circuit, and summing the different fluxes. (Left to right is assigned positive and right to left assigned negative.) When considered looking from left to right, the current flowing clockwise in the choke pl₁ and sl₁ produces a flux that flows from left to right through the upper leg, whereas an anti-clockwise current would produce a flux flowing from right to left. Thus, at time t₀ to time t₁, the flux through the upper leg is the result of 1/2Φ(pt₁)+Φ(pl₂+sl₁) (where Φ(winding) indicates the flux due to the specified winding). Similarly, the flux through the centre leg is—Φ(pt₁)−Φ(Pl₁+sl₁)+Φ(Pl₂+sl₂), and that through the lower leg is 1/2Φ(pt₁)−Φ(pl₂+Sl₂).

It will be seen that flux from the primary and secondary windings for the first choke flows through the centre leg from right to left in FIGS. 7 to 9. The primary and secondary windings for the second choke are also wound in an anticlockwise sense compared to the primary choke, and therefore its flux flows from left to right through the centre leg, in the opposite direction to the flux generated by the first choke. The current flows through the transformer winding in different directions in different parts of the transformer cycle, the flux due to the transformer sometimes flows from left to right and sometimes flows from right to left.

In a conventional integrated magnetics winding arrangement, for example in a uk converter (shown for example in U.S. Pat. No. 4,257,087), the primary choke is arranged so that current flows around the respective legs in the same sense; that is, if the current in the primary choke flows in a clockwise sense when considered in a particular direction, the current in the secondary choke also flows in the clockwise direction. Thus, the flux due to the first choke windings in the centre leg will be acting in the same direction as the flow due to the second choke windings in the centre leg. The total flux in the centre leg will be the sum of the magnitudes of all the fluxes, Φ(pt₁)+Φ(pl1+sl1).

In the present circuit, the flux due to the first choke windings in the centre leg will be acting in the opposite direction as the flow due to the second choke windings in the centre leg, and therefore tend to partly cancel (though of course the magnitudes of the fluxes will be differently varying and therefore generally not fully cancel). Therefore, the total flux in the centre leg will sometimes be equal to −Φ(pt1)−Φ(pl1+sl1)+Φ(pl2+sl2), whilst when the transformer current is flowing in the opposite direction, the total flux in the centre leg will be equal to +Φ(pt1)−Φ((pl1+sl1)+Φ(pl2+sl2), using a left to right notation for positive flux and right to left notation for negative flux.

In general, the total flux in the centre leg will thus be less when the current in the first and second chokes are flowing around their respective legs in opposite senses than when they are flowing in the same sense. Referring to FIG. 11, the separate fluxes due to the first choke, the transformer, and the second choke are shown in the upper leg, centre leg, and lower leg respectively are shown. Combining the components as outlined above gives a result for the upper, centre and lower legs as shown in FIG. 12. It will be see that at times t₀+½ and t₂+½ the magnetic flux in the centre leg is zero. This is due to the interleaving operation of the first and second chokes and the magnetising current of the transformer.

A leg of the core can carry a particular amount of magnetic flux, dependent upon the material of the core and upon the cross sectional area of the leg. When the maximum magnetic flux density is reached, the core is said to saturate and cannot carry further flux.

It will be noted that the flux flowing through the centre leg is relatively small when compared to the upper and lower legs. Thus the cross sectional area of the centre leg may be reduced to a quarter of the conventional size, to a size approximately one half that of the cross section of either the upper or the lower leg. The resulting flux densities through the upper, centre and lower legs as shown in FIG. 13. The positive and negative peak flux density through the centre leg is less than that of the either the upper or lower legs.

By reducing the size of the centre leg of the transformer, the total size and weight of the transformer may be reduced. The reduced size ofthe centre leg also reduces the length of the transformer windings, achieving savings in power loss. Additionally, the power loss due to the core losses is minimized. This is achieved by using the outer legs as part of the transformer. The increased cross sectional area reduces the flux change, thereby reducing the core loss.

These benefits detailed above are in addition to the benefits gained from the typical application of integrated magnetics.

It will be seen that the reduction in total flux flowing through the centre leg will result from any arrangement where the flux generated by the first and second chokes are generally opposing. The current in the first choke could of course flow in an anticlockwise sense referring to FIGS. 7 to 10, provided that of the second choke flowed in a clockwise sense. A particular winding may be wound using a either a right-handed or left-handed helix, since the current could be caused to flow in either direction depending on the connection of the windings terminals. However, the system shown in the drawings, where each winding is made using a right-handed helix, is convenient. The winding of the primary transformer coil may be in either sense, since the current will flow in both directions over the course of a cycle.

It will be seen that many aspects of the transformer may be varied whilst still utilising the principles disclosed herein to reduce the core losses and/or to reduce the size of the core. In particular, modifications of the switching circuit, and circuit components designed to smooth the output or reduce losses, may be incorporated.

Furthermore, the composition of the core could be a single material, like ferrite, or a composition of materials like ferrite and molypermalloy or ferrite and amorphous alloy. Using these techniques, the size can be further reduced or the throughput power increased.

1. A continuous DC-to-DC converter comprising:
a transformer having two outer legs and a middle leg,
a primary side comprising
a first primary inductor wound on one outer transformer leg and connected between one side of the DC input and a first capacitor,
a second primary inductor wound on the other outer transformer leg and connected between one side of the DC input and a second capacitor,
first switching means comprising a change-over switch connecting the other side of the DC input to the two sides of the first capacitor,
second switching means comprising a change-over switch connecting the other side of the DC input to the two sides of the second capacitor, and
a common inductor wound on the middle transformer leg and connected to the first and second capacitors on the sides opposite the first and second inductors respectively, and
a secondary side comprising a bridge circuit having two adjacent legs forming secondary inductors wound on the respective outer transformer legs, two adjacent legs including respective rectifying means, and a cross path forming a common secondary winding on the middle transformer leg,
the first and second primary inductors being wound on the respec-tive legs of the transformer in opposite senses, such that corre-sponding currents through them induce magnetic fluxes in opposite directions through the middle transformer leg,
characterized in that
the cross-sectional area of the middle leg is less than that of each of the two outer legs.

2. A DC to DC converter having a transformer including primary and secondary transformer windings, a first primary and secondary choke winding, and a second primary and secondary choke winding, and a control means that switches current to flow through the first primary choke winding and the primary transformer winding, and/or through the second primary choke winding and the primary transformer winding so as to induce a current in the secondary transformer winding, the first primary and secondary choke windings being magnetically associated with a first core member, the primary and secondary transformer windings being magnetically associated with a second core member, and a second primary and secondary choke winding being magnetically associated with a third core member, characterized in that the second core member has a cross sectional area equal or less than approximately half the cross sectional area of either the first core member or the third core 3.A DC-DC transformer including primary and secondary transformer windings, a first primary and secondary choke winding, and a second primary and secondary choke winding, and a control means that switches current to flow through the first primary choke winding and the primary transformer winding, and/or through the second primary choke winding and the primary transformer winding so as to induce a current in the secondary transformer winding, the first primary and secondary choke windings being magnetically associated with a first core member, the primary and secondary transformer windings being magnetically associated with a second core member, and a second primary and secondary choke winding being magnetically associated with a third core member, characterized in that the second core member has a cross sectional area equal or less than approximately half the cross sectional area of either the first core member or the third core member.

3. A converter according to either claim 1, wherein the core members are formed from two ‘E’-shaped core halves.

4. A transformer as defined by claim 1.

5. A core member as defined by claim 4.

6. A transformer as herein described and illustrated.

7. A transformer element for transforming a voltage from a primary circuit to a secondary circuit, the transformer element including (a) part of the primary circuit including a first induction winding, a transformer winding, a second inductor winding, (b) part of the secondary circuit including a first induction winding, a transformer winding, a second inductor winding, and (c) a core means that extends through one or more of the windings, characterized in that one or more of the windings through which the core means extend is disposed upon a forming element discrete from the core means and through which the core means extends.

8. A transformer element according to claim 7 characterized in that the first primary inductor winding and the first secondary inductor winding are disposed on a first forming element, the primary transforming winding and secondary transformer winding are disposed on a second forming element, and the second primary inductor winding and second secondary inductor winding are disposed on a third forming element.

9. A transformer element according to claim 8 characterized in that the second forming element is secured directly to the first and third forming elements.

10. A transformer element according to claim 7 characterized in that the first and third forming elements each includes an integral spacing portion which constrains the respective primary inductor winding and the secondary inductor winding in a spaced relationship.

11. A transformer element according to claim 7 characterized in that the primary transforming winding and secondary transformer winding are arranged in an overlapping configuration.

12. A transformer element according to claim 7 characterized in that the winding comprises an elongate conducting element, this conducting element comprising a turn portion which is wound into a number of turns around the circumference of the forming element, and connecting portions, which connect the turn portion to the primary or secondary circuit, and that the forming element includes channels or protuberances to guide and/or secure the connecting portions.

13. A transformer element according to claim 7 characterized in that the winding comprises an elongate conducting element, this conducting element comprising a turn portion which is wound into a number of turns around the circumference of the forming element, and connecting portions, which connect the turn portion to the primary or secondary circuit, and that the forming element includes a groove accept part of the connecting portion, the turn portion being formed above this groove.

14. A transformer element according to claim 9 characterized in that the securement is achieved using snap-fit clip means.

15. A transformer ccording to claim 7 characterized in that the core element comprises two generally ‘E’ shaped core halves, each having three parallel limbs lying in the same plane and a common backbone approximately perpendicular to the limbs.

16. A method of manufacturing a transformer element for transforming a voltage from a primary circuit to a secondary circuit, comprising the steps of winding an primary elongate conductor to a forming means, winding a secondary conductor to a forming means, connecting the primary elongate conductor to the primary circuit and the secondary elongate conductor to the second circuit, and introducing a core means to the forming means subsequent to the conducting means having been wound upon the forming means.

17. A method according to claim 16 further characterized by
winding a first primary inductor winding and a first secondary inductor winding onto a first forming element,
winding a primary transforming winding and a secondary transformer winding onto a second forming element,
winding a second primary inductor winding and a second secondary inductor winding onto a third forming element,
inserting a first core element having three limbs into the first second and third forming elements, and
inserting a second core element having three limbs into the first second and third forming elements, from the opposite side to the first core element,
the insertion of the core elements into the forming elements being carried out subsequently to winding the inductor windings and transformer windings onto the forming elements.

18. Canceled.
